(19) United States
(12) Patent Application Publication
(10) Pub. No.: US 2025/0102823 A1
(43) Pub. Date: Mar. 27, 2025

(54) NAKED-EYE THREE-DIMENSIONAL IMAGING DEVICE

(71) Applicant: Gaodi Digital (Qingdao) Co., Ltd., Qingdao (CN)

(72) Inventor: Zhujun Chen, Qingdao (CN)

(21) Appl. No.: 18/425,877

(22) Filed: Jan. 29, 2024

(30) Foreign Application Priority Data
Sep. 22, 2023 (CN) 202322594017.1

(51) Int. Cl. G02B 30/22; G02B 27/01

(52) U.S. Cl. CPC G02B 30/22; G02B 27/0172; G02B 2027/0136; G02B 2027/014

(57) ABSTRACT

A naked-eye three-dimensional imaging device includes an objective lens module including a first and objective lenses arranged at intervals of a pupil distance, a display module including a first display screen for displaying a shooting image of the first objective lens, and a second display screen for displaying a shooting image of the second objective lens, an observation member including a first and second observation chambers respectively connected to the first and second display screens, an eyepiece module including a first eyepiece and a second eyepiece respectively arranged at eyepiece ends of the first and second observation chambers, and an eyepiece focusing module between the eyepiece module and the observation member, and including a first focusing member and a second focusing member for respectively adjusting a distance between the first eyepiece and the first display screen, and a distance between the second eyepiece and the second display screen.

### CROSS-REFERENCE TO RELATED APPLICATION

This application claims priority to Chinese Patent Application No. 202322594017.1, titled “NAKED-EYE THREE-DIMENSIONAL IMAGING DEVICE” and filed to the China National Intellectual Property Administration on Sep. 22, 2023, the entire contents of which are incorporated herein by reference.

### TECHNICAL FIELD

The present disclosure relates to the field of cameras, and especially relates to a naked-eye three-dimensional imaging device.

### BACKGROUND

A two-dimensional (2D) image is generally presented in a conventional camera that is very friendly for taking photos, but there are limitations for video shootings or observations by the conventional camera, so that it is difficult to accurately observe an actual scene by the conventional camera.

With the development of technologies, a three-dimensional (3D) camera has appeared on the market. However, a conventional 3D camera basically includes a single lens that is combined with image processing, to process an image into two images with a pupil distance deviation, thereby forming a naked-eye three-dimensional image captured by eyes of users. Such way needs high requirements for image processing software, and if the images are not processed properly, it will affect a final effect of the images and easily produce defects at edges of the images. Moreover, the conventional 3D camera is unable to adjust refraction thereof, which results in poor visual experiences for users with poor visions.

### SUMMARY

The technical problems to be solved: in view of the shortcomings of the related art, an objective of the present disclosure is to provide a naked-eye three-dimensional imaging device which can adjust refraction thereof.

To achieve the above objective, a naked-eye three-dimensional imaging device according to an embodiment of the present disclosure includes:
an objective lens module including a first objective lens and a second objective lens arranged at intervals according to a pupil distance thereof;
a display module including a first display screen configured to display a shooting image of the first objective lens, and a second display screen configured to display a shooting image of the second objective lens;
an observation member including a first observation chamber connected to the first display screen, and a second observation chamber connected to the second display screen;
an eyepiece module including a first eyepiece arranged at an eyepiece end of the first observation chamber, and a second eyepiece arranged at an eyepiece end of the second observation chamber; and wherein each of the first eyepiece and the second eyepiece includes a fixed mirror group including at least one fixed mirror, and a moving mirror group including at least one moving mirror; and
an eyepiece focusing module connected to the at least one moving mirror and configured to a distance between the at least one moving mirror and the at least one fixed mirror, the eyepiece focusing module including a first focusing member configured to adjust the first eyepiece, and a second focusing member configured to adjust the second eyepiece.

The present disclosure provides the advantages as below: the present disclosure provides that the first objective lens and the second objective lens are arranged at intervals according to a pupil distance thereof so as to simulate eyes of users, so that the image processing module can display a pupil distance deviation on the first display screen and the second display screen without performing pupil distance deviation processing thereof. In this way, users can observe an image captured by the first objective lens from the first display screen through the first eyepiece and the first observation chamber, and also can observe an image captured by the second objective lens from the second display screen through the second eyepiece and the second observation chamber, so as to obtain a 3D image by the present disclosure because the first objective lens and the second objective lens are arranged at intervals according to the pupil distance thereof. Due to the pupil distance deviation being formed between the first objective lens and the second objective lens, there is no need for special processing by the image processing module, which simplifies difficulties of software processing to quickly obtain high-quality 3D images. The first eyepiece is equipped with the first focusing member, and the second eyepiece is equipped with the second focusing member, so that the two eyepieces can independently adjust their respective refractions, which can not only adapt to users with different visions, but also adapt to users with differences between left and right eyes, thereby allowing users with poor visions to experience 3D images. Furthermore, each of the first eyepiece and the second eyepiece includes the fixed mirror group and the moving mirror group, so that a combination of the fixed mirror group and the moving mirror group can greatly reduce an adjustment stroke and reduce distortion thereof.

### BRIEF DESCRIPTION OF THE DRAWINGS

FIG. 1 is a schematic view of a naked-eye three-dimensional imaging device in accordance with an embodiment of the present disclosure.

FIG. 2 is similar to FIG. 1, but shown from another view.

FIG. 3 is a cross sectional view of the naked-eye three-dimensional imaging device of FIG. 1.

FIG. 4 is a schematic view of an inner structure of the naked-eye three-dimensional imaging device of FIG. 1.

FIG. 5 is similar to FIG. 4, but shown from another view.

FIG. 6 is an exploded, schematic view of an eyepiece focusing module of the naked-eye three-dimensional imaging device of FIG. 1.

FIG. 7 is a schematic view of an eyepiece module of the naked-eye three-dimensional imaging device of FIG. 1.

The element labels according to the embodiment of the present disclosure shown as below:

100 objective lens module, 101 first objective lens, 102 second objective lens, 200 display module, 201 first display screen, 202 second display screen, 300 observation member, 310 first observation chamber, 320 second observation chamber, 330 connecting plate, 331 battery compartment, 400 eyepiece module, 401 first eyepiece, 402 second eyepiece, 410 fixed mirror group, 411 fixed mirror, 412 quasi flat concave lens, 420 moving mirror group, 421 moving mirror, 422 meniscus lens, 423 sliding block, 430 eye protection member, 431 first eye protecting portion, 432 second eye protecting portion, 500 eyepiece focusing module, 501 first focusing member, 502 second focusing member, 510 connecting cylinder, 511 linear guiding groove, 520 inner rotating cylinder, 521 curve guiding groove, 522 bump, 530 outer rotating cylinder, 531 slot, 601 first image module, 602 second image module, 700 main circuit board, 710 control button, 720 battery, 721 circuit management module, 722 interface, 723 first memory card, 724 second memory card, 800 supplementary light device, 810 supplementary light control module, 900 housing, 910 objective lens cover, 920 main body, 921 connecting portion, 922 ring, 930 decorative cover.

### DETAILED DESCRIPTION

In order to more clearly understand the technical solution hereinafter in embodiments of the present disclosure, a naked-eye three-dimensional imaging device of the present disclosure will now be made in detail to embodiments, examples of which are illustrated in the accompanying drawings. It should also be understood that the terms used in the specification of the present disclosure are only for the purpose of describing specific embodiments without being intended to limit the present disclosure.

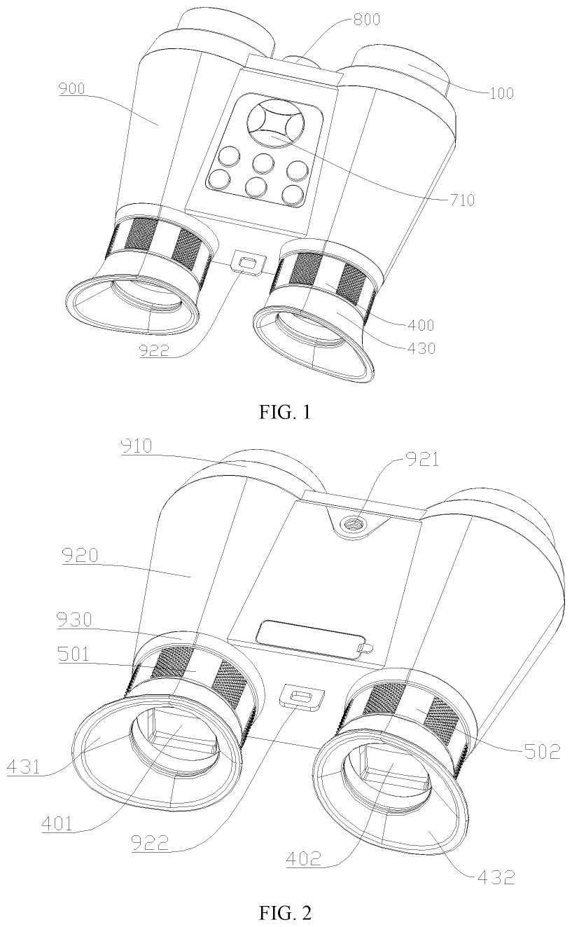

Referring to FIG. 1 to FIG. 7, a naked-eye three-dimensional imaging device in accordance with an embodiment of the present disclosure includes:
an objective lens module 100 including a first objective lens 101 and a second objective lens 102 arranged at intervals according to a pupil distance thereof;
a display module 200 including a first display screen 201 configured to display a shooting image of the first objective lens 101, and a second display screen 202 configured to display a shooting image of the second objective lens 102;
an observation member 300 including a first observation chamber 301 connected to the first display screen 201, and a second observation chamber 302 connected to the second display screen 202;
an eyepiece module 400 including a first eyepiece 401 arranged at an eyepiece end of the first observation chamber 301, and a second eyepiece 402 arranged at an eyepiece end of the second observation chamber 302. Each of the first eyepiece 401 and the second eyepiece 402 includes a fixed mirror group 410 including at least one fixed mirror 411, and a moving mirror group 420 including at least one moving mirror 421; and
an eyepiece focusing module 500 connected to the at least one moving mirror 421 and configured to adjust a distance between the at least one moving mirror 421 and the at least one fixed mirror 411, the eyepiece focusing module 500 including a first focusing member 501 configured to adjust the first eyepiece 401, and a second focusing member 502 configured to adjust the second eyepiece 402.

The first objective lens 101 and the second objective lens 102 are arranged at intervals according to the pupil distance thereof so as to simulate eyes of users, so that the image processing module can display a pupil distance deviation on the first display screen 201 and the second display screen 202 without performing pupil distance deviation processing thereof. In this way, users can observe an image captured by the first objective lens 101 from the first display screen 201 through the first eyepiece 401 and the first observation chamber 310, and also can observe an image captured by the second objective lens 102 from the second display screen 202 through the second eyepiece 402 and the second observation chamber 320, so as to obtain a 3D image by the present disclosure because the first objective lens 101 and the second objective lens 102 are arranged at intervals according to the pupil distance thereof. Due to the pupil distance deviation being formed between the first objective lens 101 and the second objective lens 102, there is no need for special processing by the image processing module, which simplifies difficulties of software processing to quickly obtain high-quality 3D images. The first eyepiece 401 is equipped with the first focusing member 501, and the second eyepiece 402 is equipped with the second focusing member 502, so that the two eyepieces independently adjust their respective refractions, which can not only adapt to users with different visions, but also adapt to users with differences in left and right eyes, thereby allowing users with poor visions to experience 3D images. Furthermore, each of the first eyepiece 401 and the second eyepiece 402 includes the fixed mirror group 410 and the moving mirror group 420, so that a combination of the fixed mirror group 410 and the moving mirror group 420 can greatly reduce an adjustment stroke and reduce distortion thereof.

Referring to FIG. 1 to FIG. 5, both the first objective lens 101 and the second objective lens 102 are included in the objective lens module 100 and arranged at intervals according to the pupil distance thereof, both the first objective lens 101 and the second objective lens 102 are camera objective lenses. The observation member 300 is arranged on a middle of the imaging device and divided into the first observation chamber 310 and the second observation chamber 320. The first display screen 201 is arranged on an objective end of the first observation chamber 310, and the first eyepiece 401 is arranged on an eyepiece end of the first observation chamber 310; while the second display screen 202 is arranged on an objective end of the second observation chamber 320, and the second eyepiece 402 is arranged on an eyepiece end of the second observation chamber 320. The first display screen 201 is configured to display a shooting image of the first objective lens 101, and the second display screen 202 is configured to display a shooting image of the second objective lens 102. A distance between the first objective lens 101 and the second objective lens 102 is equal to a distance between the first eyepiece 401 and the second eyepiece 402. Each of the first eyepiece 401 and the second eyepiece 402 includes the fixed mirror group 410 and the moving mirror group 420. The fixed mirror group 410 is fixed and the moving mirror group 420 moves under an adjustment of the eyepiece focusing module 500. The first eyepiece 401 is connected to the first focusing member 501, and the second eyepiece 402 is connected to the second focusing member 502.

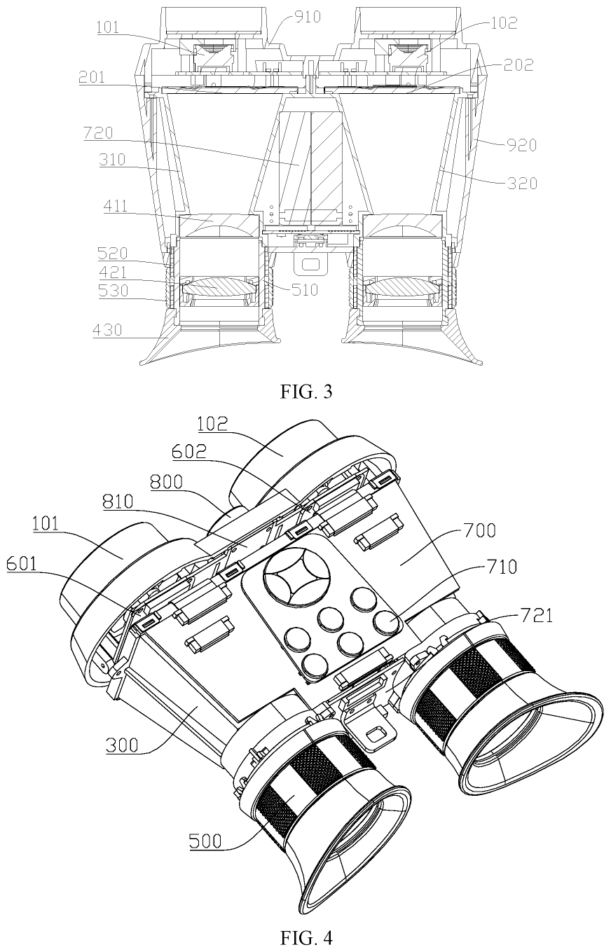

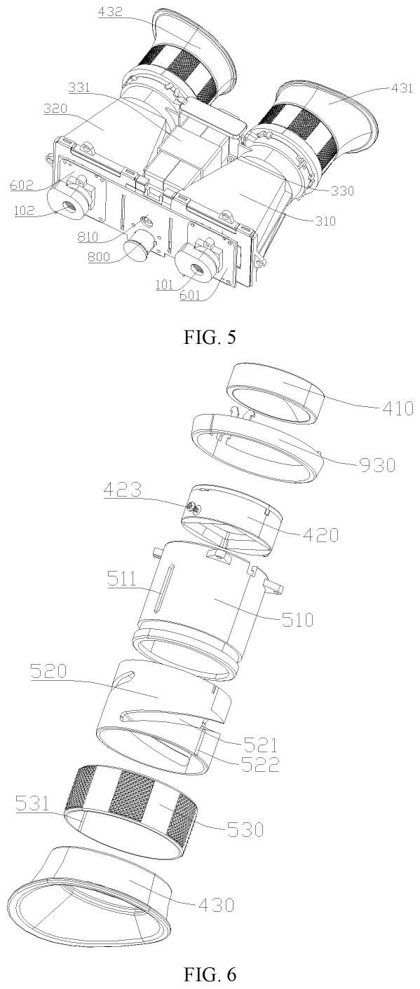

Referring to FIG. 3 and FIG. 5, a width of each of the first observation chamber 310 and the second observation chamber 320 gradually narrows from the display module 200 to the eyepiece module 400, which can provide a more comfortable observation effect and can be configured with a larger display screen, resulting in a higher resolution and a clarity of the image. It can be understood that the width of each of the first observation chamber 310 and the second observation chamber 320 gradually narrows from the display module 200 to the eyepiece module 400, which is only limited to a wide screen thereof, that is, a screen size is larger than an inner diameter of the eyepiece module 400. When the screen size is equal to the inner diameter of the eyepiece module 400, the observation member 300 can be a cylindrical or rectangular structure, and when the screen size is smaller than the inner diameter of the eyepiece module 400, the observation member 300 can be an inverted trapezoidal structure.

Referring to FIG. 4 and FIG. 5, the imaging device further includes an image processing module that includes a first image module 601 and a second image module 602; both the first objective lens 101 and the first display screen 201 coupled to the first image module 601, and both the second objective lens 102 and the second display screen 202 coupled to the second image module 602.

Referring to FIG. 4 and FIG. 5, the imaging device further includes a main circuit board 700, each of the first image module 601, the second image module 602, the first display screen 201 and the second display screen 202 electrically connected to the main circuit board 700. On the one hand, the main circuit board 700 is configured to comprehensively process images that are captured and adjust differences between the two images, to ensure that the two images are presented as a 3D image. On the other hand, the main circuit board 700 is configured to facilitate control, such as a brightness control and a shooting focus control, etc.

Referring to FIG. 1 and FIG. 5, the imaging device further includes a supplementary light device 800 arranged between the first objective lens 101 and the second objective lens 102, and electrically connected to the main circuit board 700. The supplementary light device 800 can be configured to perform night vision observation through image processing. Simply, the supplementary light device 800 is connected to a supplementary light control module 810 that can be set separately or coupled to the main circuit board 700. Preferably, the supplementary light device 800 is an infrared lamp or a low light lamp, so that the imaging device is to have a night vision function.

Referring to FIG. 4 and FIG. 5, the first image module 601 and the second image module 602 are vertically arranged on the imaging device. The main circuit board 700 is horizontally arranged on the imaging device, and arranged on a side of the observation member 300. Specifically, all the first image module 601, the second image module 602 and the supplementary light control module 810 are coupled to a PCB for easily installing the imaging device.

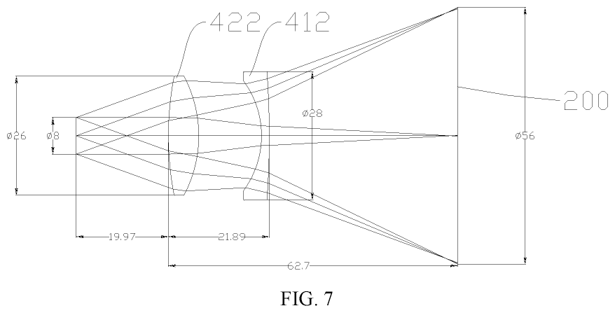

Referring to FIG. 3 and FIG. 7, the fixed mirror group 410 includes a flat concave lens or a quasi flat concave lens 412, wherein one side of the flat concave lens or the quasi flat concave lens 412 facing the display module 200 is a flat surface or a slightly convex surface, and the other side of the flat concave lens or the quasi flat concave lens 412 facing away from the display module 200 is a concave surface; the moving mirror group 420 includes a meniscus lens 422, wherein a curvature of a side of the meniscus lens 422 facing the display module 200 is greater than a curvature of a side of the meniscus lens 422 facing away from the display module 200. By combining the meniscus lens 422 and the flat concave lens or the quasi flat concave lens 412, an adjustment stroke can be greatly reduced and distortion can also be reduced. Through experiments, it has been found that both the flat concave lens (one side is flat and the other side is concave) and the quasi flat concave lens 412 (one side is slightly convex and the other side is concave) can reduce the adjustment stroke. Compared to the flat concave lens, the quasi flat concave lens 412 can reduce the distortion better.

For example, for a same focal length of 78 mm, a magnification is about 4.2 times. A conventional single eyepiece has only one lens (usually it's a biconvex lens), and for every 100 degrees of refractive adjustment, the lens needs to be moved nearly 6 mm to achieve a desired effect thereof, while a distortion can only be controlled by about 3%. However, the eyepiece of the present disclosure adopts a combination of the moving mirror group 420 and the fixed mirror group 410, as shown in FIG. 7, the meniscus lens 422 is taken as the moving mirror group 420, and the quasi flat concave lens 412 is taken as the fixed mirror group 410. In this way, the combination of the meniscus lens 422 and the quasi flat concave lens 412 of the present disclosure only requires a stroke of 1.1 mm for every 100 degrees of refractive adjustment, and the distortion is less than 0.5%, which can greatly shorten the stroke of refractive adjustment and greatly reduce the distortion of the imaging device, thereby bringing a better user experience.

It is taken the eyepiece module 400 formed by the combination of the meniscus lens 422 and the quasi flat concave lens 412 shown in FIG. 7 as an example, whether it is for myopia adjustment or farsightedness adjustment, the adjustment stroke is very short, and the visual effect is good with a low distortion.

TABLE 1
a relationship between adjustment movements and visual
acuity of the eyepiece module shown in FIG. 7

Movement of the moving mirror group (mm)

| visual acuity | myopia | farsightedness |
|---|---|---|
| 100 | −1.19 | 0.90 |
| 200 | −2.62 | 1.8 |
| 300 | −4.44 | 2.48 |
| 400 | −6.76 | 3.09 |
| 500 | −9.91 | 3.61 |

Preferably, the distortion of each of the first eyepiece 401 and the second eyepiece 402 is less than or equal to 1%. By combining the moving mirror group 420 and the fixed mirror group 410, the distortion can be theoretically reduced to be less than or equal to 0.5%, which depends on the lens that is selected.

Preferably, a distance between the fixed mirror group 410 and the moving mirror group 420 can be adjusted between 0-30 mm. That is, the stroke of the moving mirror group can be adjusted between 0-30 mm.

Referring to FIG. 1 to FIG. 4, the imaging device further includes a housing 900, the objective module 100 arranged at one end of the housing 900, and the eyepiece module 400 arranged at the other end of the housing 900, and both the display module 200 and the observation member 300 received in the housing 900. It can be understood that the housing 900 can be composed of a plurality of components that is connected together, such as an objective lens cover 910 and a main body 920 connected to the objective lens cover 910. The main body 920 can be integrated, or a separated structure that is connected by upper and lower connections according to needs. A decorative cover 930 can be installed between the eyepiece module 400 and the main body 920 to avoid gaps from being formed between the eyepiece module 400 and the main body 920. The decorative cover 930 is buckled to the main body 920.

Referring to FIG. 1 and FIG. 4, the imaging device further includes a control button 710 exposed out of the housing 900 and electrically connected to the main circuit board 700. Generally, the button 710 is set on a top of the imaging device, or can be set on a side of the imaging device as needed.

Referring to FIG. 2, a connecting portion 921 and a ring 922 are respectively arranged on the housing 900. The connection portion 921 is generally a screw hole configured to screw a bracket. The ring 922 is configured to connect ropes for easily carrying the imaging device.

Simply, the fixed mirror group 410 is fixed to the housing 900. Alternatively, as another embodiment of the present disclosure, referring to FIG. 3, the fixed mirror group 410 is fixed to the observation member 300. A connection way can be a screw connection, a nesting connection, a bonding connection, or even a welding connection.

Referring to FIG. 3 and FIG. 5, a battery compartment 331 is arranged between the first observation chamber 310 and the second observation chamber 320, and a battery 720 received in the battery compartment 331 and electrically connected to the main circuit board 700. The battery compartment 331 is arranged between the first observation chamber 310 and the second observation chamber 320, which is conducive to minimizing the imaging device and reasonably using spaces of the imaging device.

Referring to FIG. 5, the first observation chamber 310 and the second observation chamber 320 are connected with each other through a connecting plate 330, and the battery compartment 331 is arranged on the connecting plate 330, which is convenient to install the battery 720, and ensure a distance between the first observation chamber 310 and the second observation chamber 320.

Referring to FIG. 5, the battery 720 is a rechargeable battery and connected to an input-output circuit board 721, an interface module 722 arranged on the input-output circuit board 721, and the input-output circuit board 721 electrically connected to the main circuit board 700.

Referring to FIG. 5, a first memory card 723 and a second memory card 724 are arranged on both sides of the interface module 722 respectively, the first memory card 723 configured to store shooting contents of the first objective lens 101, and the second memory card 724 configured to store shooting contents of the second objective lens 102, and both the first memory card 723 and the second memory card 724 electrically connected to the interface module 722. Storage contents of the first memory card 723 and the second memory card 724 can be output to a computer through the interface module 722, and then the storage contents can be further synthesized into a standard 3D file with a left and right parallax format through a synthesis software of the computer, which is convenient for viewing a 3D image by other 3D devices (such as 3D glasses).

Referring to FIG. 3 and FIG. 6, each of the first focusing member 501 and the second focusing member 502 includes a connecting cylinder 510 that is a stator, an inner rotating cylinder 520 and an outer rotating cylinder 530. The connecting cylinder 510 includes a linear guiding groove 511 thereof, the inner rotating cylinder 520 sleeved around the connecting cylinder 510, and a curve guiding groove 521 arranged on the inner rotating cylinder 520; and wherein the outer rotating cylinder 530 sleeves around the inner rotating cylinder 520 so that the inner rotating cylinder 520 rotates with a rotation of the outer rotating cylinder 530, a sliding block 423 arranged on the moving mirror group 420 and passing through the linear guiding groove 511 to match with the curve guiding groove 521, and the sliding block 423 following the rotation of the inner rotating cylinder 520 to move in a straight line along the linear guiding groove 511. Specifically, in order to improve movement stability of the moving mirror group 420, there are two sliding blocks 423 can be symmetrically arranged, correspondingly, there are also two linear guiding grooves 511 symmetrically arranged, and two curve guiding grooves 521 symmetrically arranged. Preferably, there are anti-slip lines arranged on an outer wall of the outer rotating cylinder 530. Preferably, the inner rotating cylinder 520 and the outer rotating cylinder 530 can rotate freely through a bump 522 being engaged with a slot 531 therebetween, that is, one of the inner rotating cylinder 520 and the outer rotating cylinder 530 includes the bump 522, the other of the inner rotating cylinder 520 and the outer rotating cylinder 530 includes the slot 531 matched with the bump 522, or a hard connection can be used as needed, such as a welding connection or a screw connection. Specifically, in order to prevent the outer rotating cylinder 530 from detaching from the inner rotating cylinder 520, a blocking ring can be installed at an end of the outer rotating cylinder 530 away from the objective module 100. The blocking ring is connected to the connecting cylinder 510, which can be connected by threads or screws, or a welding connection as needed.

Referring to FIG. 1 to FIG. 3, the imaging device further includes an eye protection member 430 including a first eye protecting portion 431 connected to the first eyepiece 401 or the first focusing member 501, and a second eye protecting portion 432 connected to the second eyepiece 402 or the second focusing member 502. It can be understood that the eye protection member 430 is generally made of skin friendly flexible materials, usually made of silicone or rubber materials. The eye protection member 430 can not only protect eyes to make wearing comfortable, but also make clear adjustments within a certain range by its own elasticity of the eye protection member 430.

It can be understood that both the first objective lens 101 and the second objective lens 102 can be conventional objective lenses, which can include mechanical manual focusing objective lenses, mechanical automatic focusing objective lenses, software focusing objective lenses and zoom objective lenses, etc.

It can be understood that the pupil distance refers to a distance between the pupils of eyes with a normal range of 55-75 mm. Different center distances can be designed according to different users to obtain different 3D images. That is, any value within the normal range can be selected in advance as the pupil distance of the present disclosure, such as 60 mm and 68 mm, etc. A plurality of specifications of pupil distance models can be set according to needs during producing the imaging device, such as children models, ordinary models and enlarged models, etc. The first objective lens 101 and the second objective lens 102 are set at intervals according to the pupil distance thereof, that is, a distance between a center of the first objective lens 101 and a center of the second objective lens 102 is equal to the pupil distance. Preferably, the distance between the center of the first objective lens 101 and the center of the second objective lens 102, a distance between a center of the first display screen 201 and a center of the second display screen 202, and a distance between a center of the first eyepiece 401 and a center of the second eyepiece 402 are equivalent.

To sum up, the naked-eye three-dimensional imaging device of the present disclosure provides that the first objective lens and the second objective lens are arranged at intervals according to a pupil distance thereof so as to simulate eyes of users, so that the image processing module can display a pupil distance deviation on the first display screen and the second display screen without performing pupil distance deviation processing thereof. In this way, users can observe an image captured by the first objective lens from the first display screen through the first eyepiece and the first observation chamber, and also can observe an image captured by the second objective lens from the second display screen through the second eyepiece and the second observation chamber, so as to obtain a 3D image by the present disclosure because the first objective lens and the second objective lens are arranged at intervals according to the pupil distance thereof. Due to the pupil distance deviation being formed between the first objective lens and the second objective lens, there is no need for special processing by the image processing module, which simplifies difficulties of software processing to quickly obtain high-quality 3D images. The first eyepiece is equipped with the first focusing member, and the second eyepiece is equipped with the second focusing member, so that the two eyepieces can independently adjust their respective refractions, which can not only adapt to users with different visions, but also adapt to users with differences between left and right eyes, thereby allowing users with poor visions to experience 3D images. Furthermore, each of the first eyepiece and the second eyepiece includes the fixed mirror group and the moving mirror group, so that a combination of the fixed mirror group and the moving mirror group can greatly reduce an adjustment stroke and reduce distortion thereof.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

1. A naked-eye three-dimensional imaging device comprising:
an objective lens module comprising a first objective lens and a second objective lens arranged at intervals according to a pupil distance thereof;
a display module comprising a first display screen configured to display a shooting image of the first objective lens, and a second display screen configured to display a shooting image of the second objective lens;
an observation member comprising a first observation chamber connected to the first display screen, and a second observation chamber connected to the second display screen;
an eyepiece module comprising a first eyepiece arranged at an eyepiece end of the first observation chamber, and a second eyepiece arranged at an eyepiece end of the second observation chamber; and wherein each of the first eyepiece and the second eyepiece comprises a fixed lens group comprising at least one fixed lens, and a moving lens group comprising at least one moving lens; and
an eyepiece focusing module connected to the at least one moving lens and configured to adjust the distance between the at least one moving lens and the at least one fixed lens, the eyepiece focusing module comprising a first focusing member configured to adjust the first eyepiece, and a second focusing member configured to adjust the second eyepiece;
wherein the moving lens group comprises a positive meniscus lens, wherein a curvature of a side of the positive meniscus lens facing the display module is greater than that of a side of the positive meniscus lens facing away from the display module.

2. The imaging device as claimed in claim 1, wherein a width of each of the first observation chamber and the second observation chamber gradually narrows from the display module to the eyepiece module.

3. The imaging device as claimed in claim 1, wherein the imaging device further comprises an image processing module that comprises a first image module and a second image module; both the first objective lens and the first display screen coupled to the first image module, and both the second objective lens and the second display screen coupled to the second image module.

4. The imaging device as claimed in claim 3, wherein the imaging device further comprises a main circuit board, each of the first image module, the second image module, the first display screen and the second display screen electrically connected to the main circuit board.

5. The imaging device as claimed in claim 4, wherein the imaging device further comprises a supplementary light device arranged between the first objective lens and the second objective lens, and electrically connected to the main circuit board.

6. The imaging device as claimed in claim 5, wherein the first image module and the second image module are vertically arranged on the imaging device, the main circuit board is horizontally arranged on the imaging device, and the main circuit board is arranged on a side of the observation member.

7. The imaging device as claimed in claim 1, wherein the fixed lens group comprises a flat concave lens or a quasi flat concave lens, wherein one side of the flat concave lens or the quasi flat concave lens facing the display module is a flat surface or a slightly convex surface, and the other side of the flat concave lens or the quasi flat concave lens facing away from the display module is a concave surface.

8. The imaging device as claimed in claim 1, wherein a distortion of each of the first eyepiece and the second eyepiece is less than or equal to 1%.

9. The imaging device as claimed in claim 1, wherein the distance between the fixed lens group and the moving lens group is adjusted between 0-30 mm.

10. The imaging device as claimed in claim 1, wherein the imaging device further comprises a housing, the objective module arranged at one end of the housing and the eyepiece module arranged at the other end of the housing, and both the display module and the observation member received in the housing.

11. The imaging device as claimed in claim 10, wherein the imaging device further comprises a control button exposed out of the housing and electrically connected to the main circuit board.

12. The imaging device as claimed in claim 10, wherein a connecting portion and a ring are arranged on the housing.

13. The imaging device as claimed in claim 10, wherein the fixed lens group is fixed to the housing.

14. The imaging device as claimed in claim 1, wherein the fixed lens group is fixed to the observation member.

15. The imaging device as claimed in claim 4, wherein a battery compartment is arranged between the first observation chamber and the second observation chamber, and a battery received in the battery compartment and electrically connected to the main circuit board.

16. The imaging device as claimed in claim 15, wherein the first observation chamber and the second observation chamber are connected with each other through a connecting plate, and the battery compartment is arranged on the connecting plate.

17. The imaging device as claimed in claim 15, wherein the battery is a rechargeable battery and connected to an input-output circuit board, an interface module arranged on the input-output circuit board, and the input-output circuit board electrically connected to the main circuit board.

18. The imaging device as claimed in claim 17, wherein a first memory card and a second memory card are arranged on both sides of the interface module respectively, the first memory card configured to store shooting contents of the first objective lens, and the second memory card configured to store shooting contents of the second objective lens, and both the first memory card and the second memory card electrically connected to the interface module.

19. The imaging device as claimed in claim 1, wherein each of the first focusing member and the second focusing member comprises a connecting cylinder that is a stator, an inner rotating cylinder and an outer rotating cylinder, the connecting cylinder comprising a linear guiding groove thereof, the inner rotating cylinder sleeved around the connecting cylinder, and a curve guiding groove arranged on the inner rotating cylinder; and wherein the outer rotating cylinder sleeves around the inner rotating cylinder so that the inner rotating cylinder rotates with a rotation of the outer rotating cylinder, a sliding block arranged on the moving lens group and passing through the linear guiding groove to match with the curve guiding groove, and the sliding block following the rotation of the inner rotating cylinder to move in a straight line along the linear guiding groove.

20. The imaging device as claimed in claim 19, wherein the imaging device further comprises an eye protection member comprising a first eye protecting portion connected to the first eyepiece or the first focusing member, and a second eye protecting portion connected to the second eyepiece or the second focusing member.
